(19) United States
(12) Patent Application Publication
(10) Pub. No.: US 2002/0183190 A1
(43) Pub. Date: Dec. 5, 2002

(54) Dielectric ceramic composite

(76) Inventors: Hitoshi Masumura, Tokyo (JP); Masatoshi Kobayashi, Tokyo (JP)

Correspondence Address: Philips Electronics North America Corporation, Corporate Patent Counsel, 580 White Plains Road, Tarrytown, NY, 10591, US

(21) Appl. No.: 10/048,039

(22) PCT Filed: May 31, 2001
(86) PCT No.: PCT/EP01/06294

(30) Foreign Application Priority Data
May 31, 2000 (JP) 2000-163353

(51) Int. Cl. C04B 35/468

(52) U.S. Cl. 501/139; 501/138; 501/137

(57) ABSTRACT

The invention provides a dielectric ceramic composite that can be burnt at a low temperature. The dielectric ceramic composite in accordance with the invention is produced by means of adding eight kinds of chemical compounds of ZnO, SiO₂, CuO, Al₂O₃, MgO, BaCO₃, B₂O₃ to (BaNdSm)TiO₃ and then wet-mixing them for three hours.

### TECHNICAL FIELD

The invention relates to a dielectric ceramic composite containing (BaNdSm)TiO₃, and to an electronic device.

### BACKGROUND OF THE INVENTION

In recent years, in the field of the high frequency equipments such as mobile phones, their size has become smaller, their performance has become higher and their price has become lower. According to such tendency, a smaller size, high-performance and less expensive price are also desired for dielectric resonators that are used in such high frequency equipments. In particular, a high relative dielectric constant and a high Q factor are required for dielectric ceramic composites that are used as materials for those dielectric resonators. A dielectric ceramic composite that meets such requirement is disclosed in Japan Patent Application Laid-Open No. 1995-104949. If dielectric ceramic composites in accordance with the above-referenced patent application are used to produce, for example, multi-layer ceramic capacitors, it is possible to obtain capacitors having good characteristics.

As materials of internal electrodes formed in the multi-layer ceramic capacitors, precious metals such as Pd, Pt and Au are used. However, if those precious metals are used as materials for the internal electrodes, there exists a problem that the material cost may become expensive. Accordingly, the use of less expensive metals such Ag may be considered instead of the use of the precious metals. However, the melting point of the Ag is about 960° C. whereas the sintering temperature for the dielectric ceramic composite disclosed in the above-referenced patent application is close to 1400° C. So, if a multi-layer ceramic capacitor is produced by combination of the Ag with the dielectric ceramic composite disclosed in the above-referenced patent application, there is a problem that the Ag may be melted out during the sintering process of the dielectric ceramic composite.

In view of the above-described background, it is an objective of the invention to provide a dielectric ceramic composite that can be sintered at a low temperature.

### SUMMARY OF THE INVENTION

In order to achieve the above-described objective, the dielectric ceramic composite according to the present invention is characterised by comprising (BaNdSm)TiO₃, ZnO, SiO₂, CuO, Al₂O₃, MgO, B₂O₃, Bi₂O₃ and either BaCO₃ or BaO. By including these materials, it becomes possible to sinter the dielectric ceramic composite at a low temperature.

In the dielectric ceramic composite according to the present invention, the total weight of the said ZnO, SiO₂, CuO, Al₂O₃, MgO, B₂O₃, Bi₂O₃ and either BaCO₃ or BaO is preferably about 20% through 30% of the weight of the said (BaNdSm)TiO₃. Additionally, a ratio of the total weight of the said ZnO, SiO₂, CuO, Al₂O₃, MgO, B₂O₃ and either BaCO₃ or BaO with the weight of the said Bi₂O₃ is preferably in a range of 0.67 to 1.50. Such the total weight or the ratio is possible to realize the high relative dielectric constant and the high Q factor.

Furthermore, in the inventive dielectric ceramic composite, the average of the grain sizes of the said SiO₂, CuO and Al₂O₃ is preferably no more than 30 nm. With such size of the grains, it becomes possible to sinter the dielectric ceramic composite at a further lower temperature.

### DETAILED DESCRIPTION OF THE INVENTION

As examples of the dielectric ceramic composite in accordance with the invention, the 1st to the 17th embodiments of the dielectric ceramic composite that are appropriate materials for single planar capacitors will be described in the following. Each of the 1st to the 17th embodiments of dielectric ceramic composites mainly contains the ceramic composite “(BaNdSm)TiO₃” comprising Ba (barium), Ti (titanium), Nd (neodymium) and Sm (samarium). Furthermore, in each dielectric ceramic composite, ZnO, SiO₂, CuO, Al₂O₃, MgO, BaO, B₂O₃ and Bi₂O₃ are added to the ceramic composite (BaNdSm)TiO₃. The method of manufacturing the 1st to the 17th embodiments of the dielectric ceramic composites will below explained.

In manufacturing the 1st to the 17th embodiments of the dielectric ceramic composites, a ceramic composite (BaNdSm)TiO₃ mainly contained in the dielectric ceramic composite is first manufactured as explained below.

Firstly, BaCO₃, Nd₂O₃, Sm₂O₃ and TiO₂ are chosen as starting materials. And the each required quantity of the BaCO₃, Nd₂O₃, Sm₂O₃ and TiO₂ was weighed. In these embodiments, for BaCO₃, Nd₂O₃, Sm₂O₃ and TiO₂, 18 mol %, 11 mol %, 4 mol % and 67 mol % are weighed respectively. After having been weighed, these weighed materials are wet-blended for three hours using zirconium beads (in the wet-blending, water is used as solvent) and then these blended materials are dried out. Thereafter, a mixture of BaCo3, Nd₂O₃, Sm₂O₃ and TiO₂ obtained in such a manner are calcined for two hours at a temperature of 1,170° C. Then, the calcined materials are wet-ground for three hours using zirconium beads (in the wet-grinding, water is used as solvent) and then the ground materials are dried out. Thus, a (BaNdSm)TiO₃ is manufactured.

In the next step, eight kinds of compounds of ZnO, SiO₂, CuO, Al₂O₃, MgO, BaCO₃, B₂O₃ and Bi₂O₃ (hereinafter, ZnO, SiO₂, CuO, Al₂O₃, MgO, BaCO₃, B₂O₃ and Bi₂O₃ may be simply referred to as “eight kinds of compounds A”) are added to the manufactured (BaNdSm)TiO₃, and then those materials are wet-blended for three hours. In the instant example, the 1st to 17th embodiments of the dielectric ceramic composites D1 to D17 are manufactured by changing the mixture rates and the grain sizes of the each compound of “the eight kinds of the compound A”. Table 1 shows the compositions of the dielectric ceramic composites D1 to D12 of the 1st to 12th embodiments and Table 2 shows the compositions of the dielectric ceramic composites D13 to D17 of the 13th to 17th embodiments.

[Table 1]

[Table 2]

Table 1 shows the weight % of each compound added to the (BaNdSm)TiO₃ when the weight % of the (BaNdSm)TiO₃ is defined as “100”. In Table 1, for the dielectric ceramic composites D1 to D5, seven kinds of compounds of ZnO, SiO₂, CuO, Al₂O₃, MgO, BaCO₃ and B₂O₃ (hereinafter, ZnO, SiO₂, CuO, Al₂O₃, MgO, BaCO₃ and B₂O₃ may be simply referred to as “seven kinds of compounds B”) are added to the (BaNdSm)TiO₃ by 10% in weight relative to the (BaNdSm)TiO₃. The remaining compound Bi₂O₃ (hereinafter, the compound Bi₂O₃ may be referred to as “one kind of compound C”) is also added to the (BaNdSm)TiO₃ by 10% in weight relative to the (BaNdSm)TiO₃. However, the respective weight % of each compound of “seven kinds of the compounds B” varies with each of the embodiments D1 to D5.

Besides, in all of the dielectric ceramic composites D1 and D6 through D12 of the 1st and the 6th through 12th embodiments, the ratio of addition of “seven kinds of compounds B” is ZnO:SiO₂:CuO:Al₂O₃:MgO:BaCO₃:B₂O₃=27.9:22.4:5.0:10.1:3.0:25.9:5.7. However, weight %s of the “seven kinds of compounds B” as a whole vary with the dielectric ceramic composites D1 and D6 through D12, or the B/Cs representing the weight % ratio of “seven kinds of compounds B” and “one kind of compound C” vary with the dielectric ceramic composites D1 and D6 through D12.

Table 1 also shows the average of the grain sizes for each of ZnO, SiO₂, CuO, Al₂O₃, MgO, BaCO₃, B₂O₃ and Bi₂O₃. The average of the grain sizes for Bi₂O₃ is not shown because Bi₂O₃ dissolves into water.

With respect to the dielectric ceramic composites D13 through D17 of the 13th through 17th embodiments shown in Table 2, the weight % of each compound equals to that of the dielectric ceramic composite D1 of the 1st embodiment but the grain size of each compound is different from that of the dielectric ceramic composite D1. Table 2 shows the grain sizes (nm) for each of the compounds used in the dielectric ceramic composites D13 through D17. Further, Table 2 also shows the grain sizes (nm) for compounds used in the dielectric ceramic composite D1.

Now, the method of manufacturing a single planar capacitor using the dielectric ceramic composites D1 through D17 will be explained. Firstly, each of the dielectric ceramic composites D1 to D17 is wet-blended for three hours using zirconium beads (in the wet-blending, water is used as solvent). And next, each of blended dielectric ceramic composites D1 to D17 is dried out, and each of dried dielectric ceramic composites D1 to D17 is ground into dried powder. Then, each of the dielectric ceramic composites D1 through D17 in dried powder is granulated while adding PVA (polyvinyl alcohol) as a binder. After granulating each of the dielectric ceramic composites D1 to D17, each of the granulated dielectric ceramic composites D1 to D17 is charged into the mold with the 16.5 mmΦ and is molded by means of a presser by a pressure of 3 tons per square centimeter. In such way, disk-like samples having a thickness of 0.7 mm are manufactured for each of the dielectric ceramic composites D1 to D17. Thereafter, these disk-like samples are sintered for two hours in the air at the temperature of 880 to 930° C. and an Ag paste is printed on each of the sintered samples and then each of the printed samples is baked at the temperature of 750° C. Thus, single planar capacitors are manufactured.

The dielectric ceramic composites of the 1st through 17th embodiments can be sintered at the temperature of about 900° C. that is lower than the sintering temperature for the conventional dielectric ceramic composites, so that the low temperature sintering can be realized.

As described above, the dielectric ceramic composites of the 1st through 17th embodiments are used to manufacture the single planar capacitor. However, the dielectric ceramic composite according to the present invention may be used to manufacture any other electronic devices than the single planar capacitor.

Examples of other electronic devices include ceramic multilayer capacitors, filters networks of passive components comprising planar capacitors as well as multlayer substrates, like a LTCC-substrate or a laminate. The construction of such devices is generally known per se by the person skilled in the art, various are present in the patent literature. The dielectric composite, especially in the preferred embodiment with a grain size of less than 50 nm, is very well suited for the application in substrates. First of all, it can be sintered at a temperature lower than the melting point of Cu, which is a standard electrode material in these substrates. Secondly, due to the grain size it can be mixed very well with other substituents of the substrate, such as epoxy in the case of a laminate. Thirdly, due to the high Q-factor, an electronic device with composite of the invention can be applied under high-frequency conditions, such as in telecom applications.

Moreover, although the dielectric ceramic composites of the 1st through 17th embodiments contain BaCO₃ in the instant example, for example BaO can be used as an alternative to BaCO₃. However, since BaO is an unstable material, it may be easier to manufacture the dielectric ceramic composites by using BaCO₃ rather than BaO.

From now on, reference is made to Table 1 to 3 for explaining some embodiment examples of the invention. At first, embodiment examples 1 to 21 of single planar capacitors were manufactured using the dielectric ceramic composites D1 to D17 of the 1st to 17th embodiments. Table 3 shows electric characteristics of each of embodiment examples 1 to 21 of single planar capacitors.

[Table 3]

The embodiment examples 1 to 5 in Table 3 are respective single planar capacitors that were manufactured by sintering the dielectric ceramic composites D1 of the 1st embodiment at the respective temperatures 870, 880, 900, 910 and 930° C. The embodiment examples 6 to 16 in Table 3 are respective single planar capacitors that were manufactured by sintering the respective dielectric ceramic composites D2 to D12 of the 2nd to 12th embodiments at the temperature of 910° C. The examples 17 to 21 in Table 3 are respective single planar capacitors that were manufactured by sintering the respective dielectric ceramic composites D13 to D17 of the 13th to 17th embodiments at the temperature of 930° C.

Relative dielectric constants and Q factors for each of the single planar capacitors are measured using an automatic bridge-type measuring equipment in a condition of 1 MHz, 1 Vrsm. Besides, temperature dependencies of capacitance TC (ppm/degree C) shown in Table 3 are temperature dependencies at the temperature of −55 to +125° C. with reference to the capacitance at the temperature of +25° C.

Referring to embodiment examples 1 to 5, it is observed that capacitors having different characteristics can be manufactured by changing the sintering temperature although these examples are used the same dielectric ceramic composite D1. Now, considering a case, for example, where a capacitor is to be applied to a capacitor component of a resonator, the capacitor should preferably have such characteristics that the relative dielectric constant be no less than 70, the Q factor be no less than 2000 and the TC be within +/−30 (ppm/° C.). Embodiment examples 2 to 5 of single planar capacitors have such characteristics that the relative dielectric constant is no less than 70, the Q factor is no less than 2000 and the TC is within +/−30 (ppm/° C.). The sintering temperature for the embodiment examples 2 to 5 is 880 to 930° C. Thus, it is found that capacitors appropriate for the capacitor component of the resonator could be obtained by using the temperature of 880 to 930° C.

Next, referring to embodiment examples 4 and 6 to 9, it can be observed that all of the single planer capacitors are appropriate for the capacitor component of the resonator since all of the single planer capacitors have the characteristics that the relative dielectric constant is no less than 70, the Q factor is no less than 2000 and the TC is within +/−30 (ppm/° C.). As for the dielectric ceramic composites D1 to D5 that are used for each of the single planar capacitors of the embodiment examples 4 and 6 to 9, the weight % of the “seven kinds of the compounds B” added to (BaNdSm)TiO₃ is all equivalent (10%) as shown in Table 1 but the ratio of each compound added to the (BaNdSm)TiO₃ is different in each embodiment. Therefore, for the purpose of obtaining capacitors which are appropriate for the capacitor component of the resonator, the ratio of each of compounds contained in the dielectric ceramic composite is not limited to a specific value. As a result, it can be observed that it is possible to obtain the capacitors appropriate for the capacitor component of the resonator even if the ratio of each of compounds contained in the dielectric ceramic composite is changed.

Referring to embodiment examples 4 and 10 to 12, their sintering temperatures are equally 910° C., and further the B/Cs for the dielectric ceramic composites D1 and D6 to D8 used in capacitors of embodiment examples 4 and 10 to 12 are equally 1 (refer to Table 1). However, weight %s of B+Cs for the dielectric ceramic composites D1 and D6 to D8 are different each other. To be more specific, the weight % of the B+C is 20% for the dielectric ceramic composite D1 used in the embodiment example 4, the weight % of the B+C is 10% for the dielectric ceramic composite D6 used in the embodiment example 10, the weight % of the B+C is 30% for the dielectric ceramic composite D7 used in the embodiment example 11, and the weight % of the B+C is 40% for the dielectric ceramic composite D8 used in the embodiment example 12. It is observed that the single planer capacitors of the embodiment examples 4 and 11 using the dielectric ceramic composites D1 and D7 (their weight ratio of B+C is within 20-30%) have the characteristics that the relative dielectric constant is no less than 70, the Q factor is no less than 2000 and the TC is within +/−30 (ppm/° C.). Therefore, it is possible to manufacture capacitors that are appropriate for the capacitor component of the resonator by keeping the weight % of B+C within 20-30%.

Referring to embodiment examples 4 and 13 to 16, although their sintering temperatures are equally 910° C., the B/Cs of the dielectric ceramic composites D1, D9 to D12 that are used therein are different each other. To be more specific, the B/C is 1 for the dielectric ceramic composite D1 and the respective B/Cs is 1.5, 2.3, 0.67 and 0.43 for the dielectric ceramic composites D9 to D12 that are used for the embodiment examples 13-16, respectively. Among the single planar capacitors of the embodiment examples 4 and 13 to 16, the single planar capacitors of the embodiment examples 4, 13 and 15 that use the dielectric ceramic composites D1, D9 and D11 having the B/C weight % in the range of 0.67 to 1.5 show acceptable characteristics that the relative dielectric constant is no less than 70, the Q factor is no less than 2000 and the TC is within +/−30(ppm/° C.). Therefore, it is possible to manufacture capacitors that are appropriate for the capacitor component of the resonator by keeping the B/C weight % in the range of 0.67 to 1.5.

Finally, referring to embodiment examples 5 and 17 to 21, although their sintering temperatures are equally 930° C., the grain sizes of SiO₂, CuO and Al₂O₃ of the dielectric ceramic composites D1, D13 to D17 that are used therein are different each other (see Table 2). Among the single planar capacitors of the embodiment examples 5 and 17 to 21, the single planar capacitors of the embodiment example 5 that uses the dielectric ceramic composites D1 having SiO₂, CuO and Al₂O₃ with their grain sizes within no more than 30 nm show acceptable characteristics that the relative dielectric constant is no less than 70, the Q factor is no less than 2000 and the TC is within +/−30(ppm/° C.). Therefore, it is possible to manufacture capacitors that are appropriate for the capacitor component of the resonator by keeping the grain sizes of SiO₂, CuO and Al₂O₃ within no more than 30 nm.

As described above, the invention provides a dielectric ceramic composite that can be sitered at a low temperature.

1. A dielectric ceramic composite characterised by comprising (BaNdSm)TiO₃, ZnO, SiO₂, CuO, Al₂O₃, MgO, B₂O₃, Bi₂O₃ and either BaCO₃ or BaO.

2. A dielectric ceramic composite as claimed in claim 1, characterized in that the total weight of the said ZnO, SiO₂, CuO, Al₂O₃, MgO, B₂O₃, Bi₂O₃ and either BaCO₃ or BaO is about 20% through 30% of the weight of the said (BaNdSm)TiO₃.

3. A dielectric ceramic composite as claimed in claim 2, characterized in that a ratio of the total weight of the said ZnO, SiO₂, CuO, Al₂O₃, MgO, B₂O₃ and either BaCO₃ or BaO with the weight of the said Bi₂O₃ is in a range of 0.67 to 1.50.

4. A dielectric ceramic composite as claimed in claim 2 or 3, characterized in that the average of the grain sizes of the said SiO₂, CuO and Al₂O₃ is no more than 30 nm.

5. An electronic device comprising the dielectric ceramic composite according to one of the claims 1-4
